(19) United States
(12) Patent Application Publication
(10) Pub. No.: US 2002/0006116 A1
(43) Pub. Date: Jan. 17, 2002

(54) Distributed content management and open broadcast system using satellites and the internet

(76) Inventor: Reed Burkhart, Walnut Creek, CA (US)

Correspondence Address: SKJERVEN MORRILL MACPHERSON LLP, Suite 700, 25 Metro Drive, San Jose, CA, 95110, US

(21) Appl. No.: 09/847,591

(22) Filed: May 2, 2001

Related U.S. Application Data
(60) Provisional application No. 60/202,370, filed on May 4, 2000.

(51) Int. Cl. H04B 7/185

(52) U.S. Cl. 370/316; 455/3.02

(57) ABSTRACT

A system is presented for distributed content management of broadband multimedia content on and between caches, local area networks, the traditional Internet, traditional data circuits, and a satellite multicast Internet overlay (direct satellite multicast to enterprise local area networks, LAN-situated caches, or single computer/device recipients) and involving sharing of the satellite multicast Internet overlay system by a plurality of users sharing the same satellite neighborhood or neighborhoods.

### CROSS REFERENCE TO RELATED APPLICATION

This application is a continuation of U.S. Provisional Application Ser. No. 60/202,370, filed May 4, 2000, which is being incorporated herein by reference in its entirety.

### BACKGROUND OF THE INVENTION

Traditional publishing and broadcasting businesses are beginning to converge with the new electronic tools of the Internet. The increasing availability of multimedia production tools makes it increasingly easy to prepare audio, video and data content for dissemination (call it publishing or broadcasting); and the popularity of the Internet has led to many users focusing on common content. But the infrastructure to distribute broadband content continues to lag behind the demand for it.

Businesses' need for and use of relevant information places higher and higher demands on the data communications infrastructures used to collect, aggregate, disseminate, analyze, and present such information. A number of useful architectures have evolved over the years since data systems were first applied to business uses, with one recent version involving function-specific access by individuals (according to the individuals business function) to disparate and dynamic sources of information presented at the location of the individual. One term for such systems is Enterprise Information Portal (or EIP); of which there are many nascent variations.

The use of the Internet by businesses creates a conflict between the best efforts nature of Internet communications and the need of businesses for an assured high level of reliability for business operations. This has resulted in the growth of specialized Internet service provisioning for businesses requiring premium levels of access for transmission, reception, storage or processing.

Variations of the Internet architecture have begun to evolve including the juxtaposition of caching systems with satellite Internet multicast downlink antenna systems to efficiently replicate popular content around the Internet near the edge of the network. This takes advantage of the ability of a cache to spread the demand for content in time (cached content will be usable for a period until it is no longer current), and the consequential ability of the satellite multicast transmission to be even more efficient by transmitting to an even larger number of sites that may receive requests for a particular piece of content within the time period of the content's currency but not necessarily at the very instant the satellite multicast system is forwarding the content.

Private satellite business data networks have been in existence for some time taking advantage of many of these properties: satellites for their broadcast/multicast efficiency, private networks for a premium level of reliability, and some ability to direct content to a particular (possibly cached) location in the business destination. However, these satellite data networks are essentially proprietary networks, either involving an entire proprietary implementation (leased or purchased ground terminal equipment, and leased or purchased satellite capacity), or share certain portions of the network (such as the satellite, or the uplink equipment) with other private networks.

### SUMMARY OF THE INVENTION

What is significantly missing for a much more useful and functional satellite business network system is the interconnection and interoperability of a plurality of such satellite business networks, that is an innovation set forth in the present invention.

The key to efficient electronic publishing of multimedia business content for a large number of recipients is to use an efficient broadcast tool such as satellites. Satellites are simply more economical than the Internet when content is destined for many locations. In addition, satellite broadcasting direct to businesses bridges last mile and first mile bandwidth gaps—at least for broadcast-worthy popular content.

The present invention is a system for providing distributed content management services (aggregation, dissemination, storage, and retrieval) over a novel shared satellite Internet multicast subsystem, as well as LANs, LAN-situated caches, the Internet, and in some instances single-computer-system destinations or sources. Additionally, the system provides functionality for reporting and charging for system use (enforced by secure encryption), that may involve free-to-air (or free-to-LAN), pay-per-view, or subscription content; together with the ability to collect for transactions resulting from the use of the system (such as a purchase developed through the use of the system, where, e.g., the system may have provided a means to educate the buyer concerning the product).

The value of an interconnected or interoperable system increases according to the number of different users connected to the system that have common interest. This shows the utility of providing a means to aggregate different business communities in a satellite neighborhood that enables any single business to gain access to other business sources and destinations, along with the other system features together lacking today: multicast directly to the business (typically a LAN with high bandwidth capability on the LAN but expensive bandwidth beyond the LAN perimeter), local caches at the business that are managed together by the system and the business (including management of content to be captured and stored as well as content to be retrieved from the cache).

One of the useful capabilities of the present invention that is lacking in any of the current systems is the ability of content contributors and recipients to easily gain access to such a shared satellite multicast Internet and caching system for individual instances of use. This points to the utility of the present inventions' innovations with regard to communicating available satellite multicast capacity and system content through the use of descriptive meta-data passed along with the content (data that constitutes one of the system aspects that the meta-data describes) or passed separately over the Internet, in either case enabling distributed management of content submission, delivery, storage, and retrieval.

Content is aggregated to the content origination subsystem through data communications links from the content source. Meta-data templates defining content delivery options are used to coordinate such aggregation. At the content origination subsystem, content is queued or multiplexed onto either the satellite Internet multicast subsystem or other point-to-point data communications network (including the traditional Internet) according to objectives of cost, quality, reliability or latency. According to selections made by the content-providing user, content-receiving user, or system operator, and using in some cases active agent software, content that is distributed may be cached on a LAN-situated cache (or single-computer-system cache) for a period for subsequent on-demand access from the cache.

By architecting the system with such distributed content management capabilities, the broadest level of sharing of the system becomes possible, from secure use of the system for virtual private transmissions within one enterprise (and perhaps select enterprise partners) to secure use of the system for retailing of generic training or news content of interest to the widest set of system recipients. The number of system users with some common element of interest with another system user(s) illustrates another facet to the sharing enabled by the present invention—namely, that by sharing, the utility of the system is expanded according to the cross-fertilization of synergistic interests, and that a new ability is created for broad selection of different sources and destinations within a single, shared system.

### BRIEF DESCRIPTION OF THE DRAWINGS

FIG. 1 is an overall system block diagram of a preferred embodiment of the present invention.

FIG. 2 illustrates an embodiment showing how notification and selection may lead to content distribution, storage, and activity logging.

FIG. 3 illustrates an embodiment showing how a satellite business neighborhood can be established in advance of the availability of a commercial version of the present invention, so as to accelerate the growth of the neighborhood that would benefit by the present invention.

FIG. 4 illustrates an embodiment showing how a satellite business network customer can be upgraded to expanded capabilities such as those of the present invention.

FIG. 5 illustrates an exemplary template for content notification and submission.

FIG. 6 is a subsystem block diagram of a preferred embodiment of the content multiplexer (a part of the content origination subsystem).

FIG. 7 illustrates an exemplary template for system availability notification.

### DETAILED DESCRIPTION OF THE INVENTION

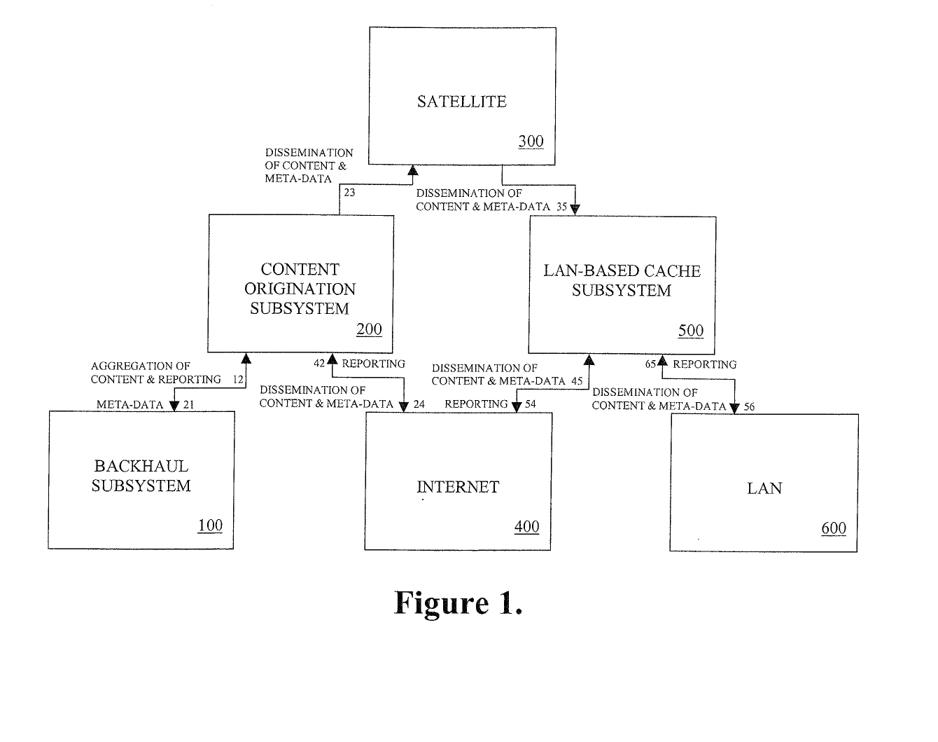

Referring now to the drawings, FIG. 1 illustrates one embodiment of the present invention.

As shown in FIG. 1, the present invention includes a backhaul subsystem 100, content origination subsystem 200, satellite 300, Internet 400, LAN-based cache system 500, and LAN 600. Content is admitted to the system according to elections by a content submitter via one of a number of system-operator-constructed content-descriptive meta-data templates describing the nature of content admissible and associated instances of availability on the system. Comprised of a number of data communications links (shared or dedicated), the backhaul subsystem 100, is used to aggregate content for submission 12, to the content origination subsystem 200.

The content origination subsystem 200, includes the systems central control including algorithms and processes for queuing, multiplexing, and optimal routing selection for content dissemination 23, 24, 35, and 45, over either the Internet 400 (or other data communications subsystem) or satellite 300 (the latter being used, e.g., for content of interest to a large number of recipients). The content origination system 200, also originates control messages to other parts of the system as well as system status information (content guide and system availability guide). Control messages and status information originating from the content origination system 200, transit either the satellite subsystem 300, or the Internet 400 (or other data communications subsystem) disseminating via 23, 24, 35 and/or 45 to the LAN-based cache 500, and thence, 56, to the LAN 600 (or single-computer system). Control messages and status information destined for the backhaul subsystem 100, are forwarded using meta-data signals that are sent either by the back-channel of the submission link 21, or via the system (satellite 300, or Internet 400, and dissemination links 23, 24, 35, and/or 45, to a LAN-based cache 500, or single-computer system coincident with the backhaul subsystem).

Content disseminates 23, 24, 35, and/or 45, to the LAN-based cache system 500 (optionally directly to a single-computer system destination) for immediate access 56, by users connected to the LAN 600 (optionally a single-computer system destination), or for on-demand access 56, by users connected to the LAN 600. Elections by recipient users on the LAN 600, are communicated either locally by reporting 65, to the cache (as necessary, triggering centralized reporting 54, and 42 via the Internet 400, to the content origination subsystem 200) or centrally from the user on the LAN 600 to the content origination subsystem 200, via the Internet 400, via reporting linkages 65, 54, and 42.

Charges by the system operator for use of the system by content contributors, recipients, and transaction-based marketing partners may include one or more of: carriage or storage charges for content transiting or stored on the system, management charges for maintaining the system, access charges for recipients gaining access to system content, and transaction fees for transactions related to system operation. Charges may be billed and collected in traditional fashion, or through the system reporting described in cooperation with online billing and payment systems.

To advance the establishment of a large number of satellite downlink systems pointed at the same satellite or satellites, traditional satellite business networks not constructed on the principals of the present invention and that are commonly independent of one another are aggregated together on one or more such satellites 300, so that they may be transitioned to an interlinked system based on other aspects of the present invention by, e.g., attaching a LAN-based cache 500, (connected to the satellite downlink) and other system elements based on the present invention. Traditional satellite business networks involve the use of a satellite to transmit to a business premise (where a LAN 600, typically exists, although it may not necessarily be connected to the satellite system or any distributed content management system). System expansion may also be achieved through enabling one system user or group of users to co-market the system to their business partners—enabling them to extend the effectiveness of their broadband multicast Intranet based on the present invention to their business partners through establishing a broadband multicast extranet based on the same system, essentially creating a set of virtual private broadband multicast networks. Another innovative marketing approach to expand system use afforded by the nature of the present invention is co-marketing of the system-operator brand with one or more of the brands carried over the system, communicating that the system provides access to the content associated with such brands, and the high-bandwidth flexible internetworked and multifunctional nature of the system implemented and branded based on the present invention.

The satellite 300, is transited with common formats such as specified in the Digital Video Broadcasting standard, i.e. QPSK modulation, and block, convolutional, or hybrid channel coding, or one of the IETF or W3C standards specifying transport stream, packetization, or protocol formats; and may involving single carrier (constant envelope) per transponder or multiple channels per transponder transmissions (preferably the former).

In some cases, the forward data path for content originating from the content origination subsystem 200, will be directed either over the satellite subsystem 300, or the Internet or other data communications network subsystem 400, according to a cost model that predicts the lowest cost path for the number of recipients anticipated to be receiving the transmission.

The content recipient users on the LAN or single computer system 600, are provided content guides (including rules for accessing system content) through meta-data transiting the system (communication links 23, 35, 24, 45, and/or 56) from which to learn of and select system-delivered content. The content guides are prepared in the content origination system 200 (and incorporate elections of the content contributors), and they include a filtered listing of content scheduled to transit the system, with such filtered listings corresponding to the individual recipient's identity or the identity of some group to which the recipient user is associated. In some embodiments, an agent program (and/or content guide software) resident on a computer either in the LAN cache subsystem 500, or the LAN/end user system 600, is used to manage (including also monitoring and reporting) the filtering of content to be selected for use (instant use or cached storage for future use), and optionally further to manage (including also monitoring and reporting) the presentation of content guides (and filtering of guide listings), presentation of rules to access content or effect transactions, and enforcement of rules to access content or effect transactions in cooperation with encryption and/or conditional access systems.

The content contributors who submit content via the aggregation and backhaul subsystem 100, produce their content according to limits specified by the system operator (such as maximum data rate, range of source coding formats for streaming media—such as MPEG 1, 2, 4, 7, or proprietary formats) and submit the content together with associated meta-data 12, according to meta-data templates specified by the system operator. The content preparation tools (e.g., compression, or source coding) used to encode content may be modified so that they may also contemporaneously produce the meta-data (such as maximum bit rate, minimum bit rate, etc.) of a prespecified type and format to be used for selection of available system capacity. Knowing in advance which content parameters are most sensitive to transmission cost (such as maximum bit rate), content production and preparation tools may use specific meta-data values as targets, limits or objectives in content preparation to generate content in a preferred constitution together with meta-data of a preferred nature for submission 12, to the content origination subsystem 200.

The form of the meta-data used throughout the system is implemented in one preferred embodiment through XML or one of its derivatives or implementations, and in another preferred embodiment through use of DVB packet headers.

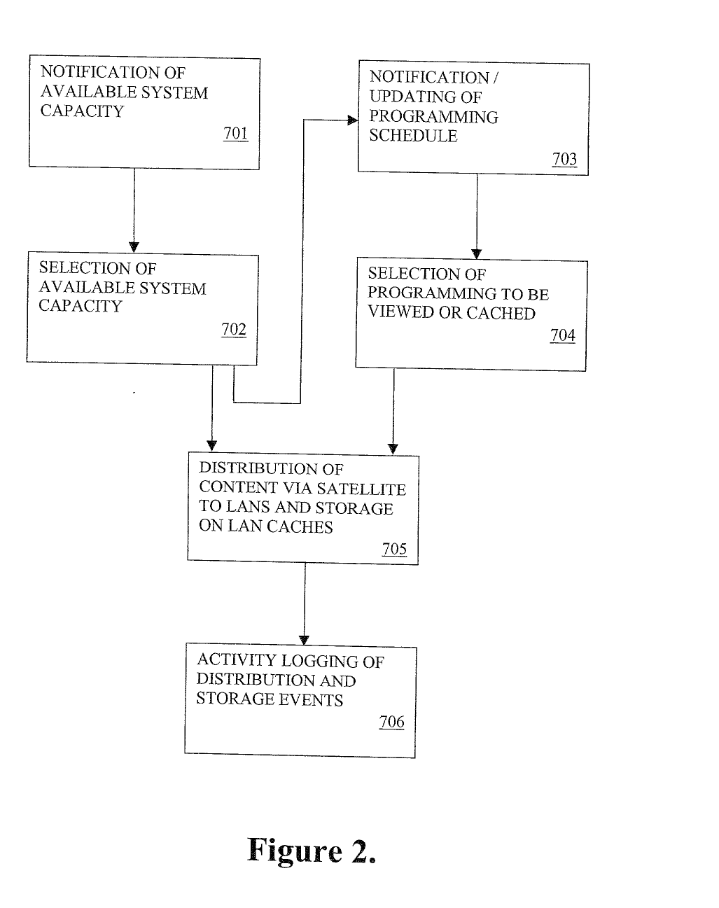

With reference to FIG. 2, there is described the process by which notification of available system capacity 701, notification of programmed content 703, selection of available system capacity by content contributors (content programmers) 702, and selection of content by content receivers 704, leads to content distribution and storage 705, and activity logging 706. At step 701, the system operator notifies prospective content contributors the available system capacity (can be through a system availability guide) via meta-data (and meta-data templates) via meta-data communication links 21, 23, 24, 35, 45, and/or 56. According to such system availability, at step 702, prospective content contributors elect on a first-come, first-served basis what, if any, system capacity they elect to use (and pay for) via meta-data (and meta-data templates) via reporting links 65, 54, 42, and/or 12 to the central control computer located in the content origination subsystem 200. According to the full current history of such elections for system capacity, at step 703, a program guide (or content guide) is produced to notify prospective receiving users of system content that may be of interest to them (and in one variation, rules for recipients to gain access to content is also produced to notify prospective receiving users of pay-per-view, or subscription offerings for certain content) via meta-data (and meta-data templates) via meta-data communication links 21, 23, 24, 35, 45, and/or 56. Based on program/content guide information (and pay-per-view or subscription offerings for certain content), at step 704, prospective content receivers select content to be received and viewed or used instantly (or alternatively cached for later use) or such selections may be delegated to a responsible 3rd party (such as a company training department, that determines who should receive what training information when), such determinations being reported to the central control computer in the content origination subsystem 200, by reporting links 65, 54, 42, and/or 12. After establishing a current version of content scheduled to be submitted, multiplexed, distributed, received and/or cached, from step 701, 702, 703, and 704, at step 705, the central control computer and content origination subsystem 200, effect aggregation through the backhaul (submission) subsystem 100, via communication links 12, multiplexing, distribution (either via the satellite 300, or Internet or other data communication subsystem 400, via communication links 23, 24, 35, 45, and/or 56) for access by designated recipients for immediate use on the LAN or individual computer 600, or cached storage 500, for later use (that in one variation may be controlled by local encryption of the cached content and conditional access provided in return for pay-per-view or subscription payments or commitments to pay). After the occurrence of any of these events (aggregation, distribution, storage, or use) recording is made and, in some cases, provided to other cooperating systems (such as billing or conditional access and encryption systems) at step 706. Notable parameters to be recorded include usage volume and time (and associated rate) and specific content and user identifiers for billing purposes, as well as eligible recipients for conditional access and encryption systems. In this preferred embodiment, all steps are iterated in order to keep information current for steps 701 and 703, and step 705 occurs as a continuous process.

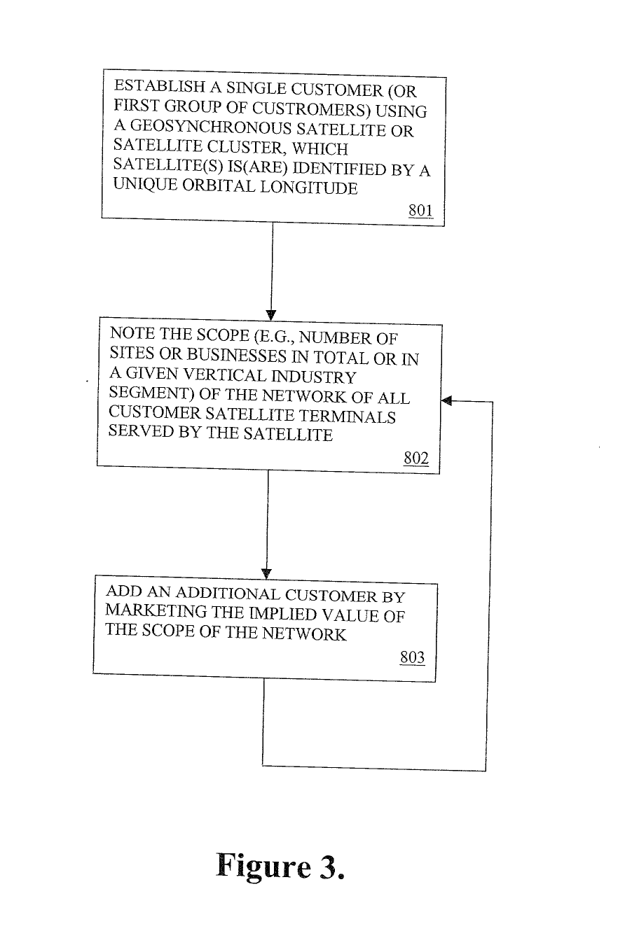

With reference to FIG. 3, there is described the process by which a satellite neighborhood is established. In step 801, an initial single customer or group of customers being served by use of a common geosynchoronous satellite orbital location is established. In step 802, the number of customers all being served from that orbital location are noted, and then in step 803, additional customers are established partly on the basis of the number of customers (or other proxy or metric showing the scope or attractiveness of the neighborhood, including specific noteworthy customers of renown) being served from a common single orbital location. This process of FIG. 3 is repeated for additional orbital locations to establish multiple regional satellite neighborhoods (e.g., a different neighborhood for each of North America, South America, Europe, S. E. Asia, Central Asia, E. Asia, Eurasia, Africa, the South Pacific Region, etc.)

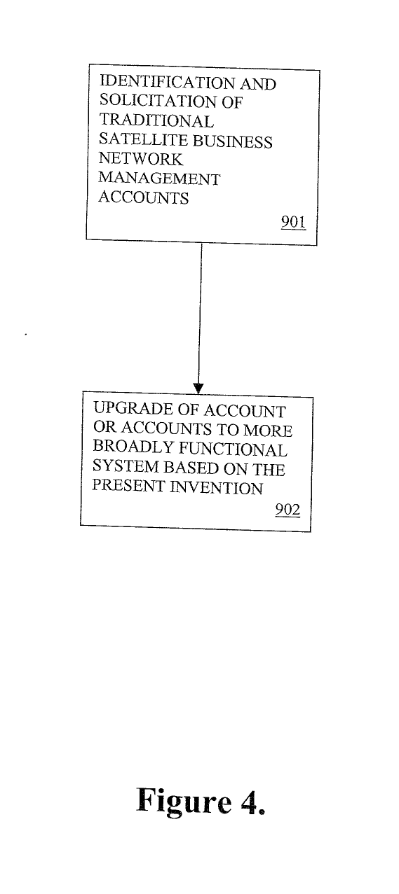

With reference to FIG. 4, customers/users established in advance of the development of a commercial version of interlinked satellite multicasting Internet overlay of the present invention are in step 901, first served as traditional customers of a business satellite network (for example a VSAT network, satellite business television network, or stand-alone or other proprietary satellite business data network), and then in step 902 are migrated to a system based on the broader functionality of the present invention—i.e. their systems are upgraded consistent with one or another embodiment of the present invention to permit access to other content sources and destinations over a common satellite multicasting network.

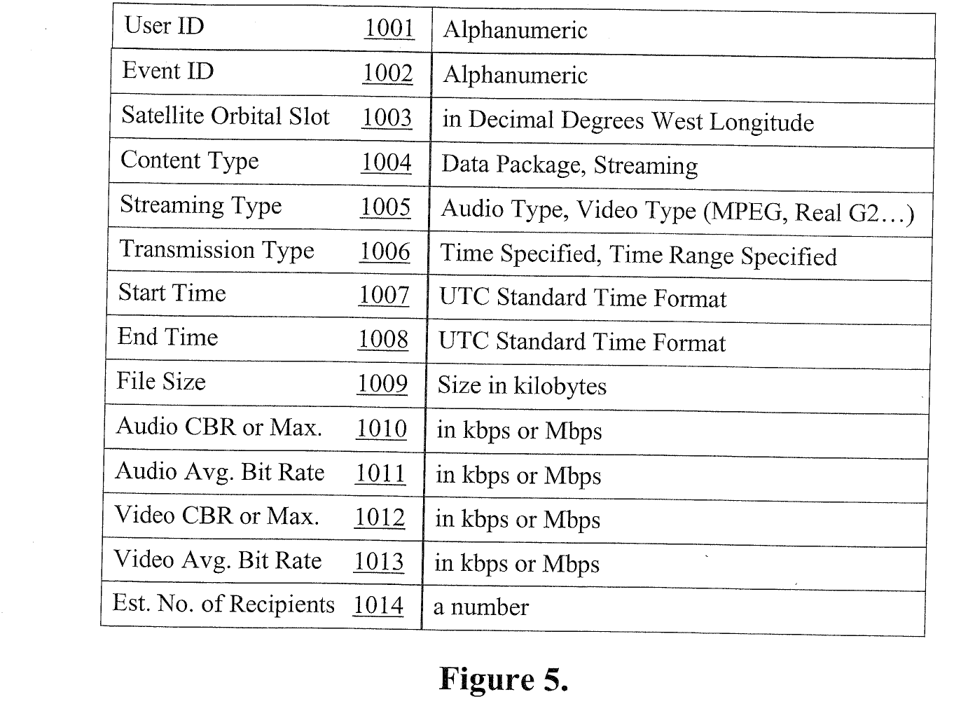

FIG. 5 illustrates an exemplary meta-data template indicating which parameters may be used and required for use in the content submission and aggregation 12, process. By using meta-data templates, the content submission process takes places between a content contributor's computer and data repository which is part of the content backhaul system 100. The template includes a list of defined variables for specification, including in this exemplary template the user's identification 1001, an event identification 1002, the satellite orbital slot 1003, the type of content 1004, more specificity of the content type in the event that the content is streaming content 1005, the temporal nature of the transmission (either a specific time, or an unspecified time bracketed by—no earlier than and no later than—two specified time limits) 1006, a start time 1007, an end time 1008, a file size 1009, a specified audio bit rate (constant or maximum, in this exemplary template determined by context of null or identical specification in average bit rate 1011) 1010, an additional specified audio bit rate (average) 1011, a specified video bit rate (constant or maximum, in this exemplary template determined by context of null or identical specification in average bit rate 1013) 1012, an additional specified video bit rate (average) 1013, an estimated number of recipients for the transmission 1014. Such a set of parameters when used to plan for content submission enable an efficient sharing of satellite capacity by a plurality of different content contributors. The user identifier 1001, for this exemplary template is a unique identification used to track all events for that user, to create billing details, etc. The event identifier 1002, is unique to each event (in alternative exemplary templates the event identifier may be unique to other than a single event, for example, when a series of events are coordinated together as a series that may be readily identified as the first, second, third, etc. sub-event in the series) providing a means to track individual events, as well as to coordinate the multiplexing process, and to control the permissioning of reception (via coordination with encryption, and conditional access systems). The orbital slot 1003, will identify which (possibly among a number of alternatives) orbital slot is intended for the specified event (in an alternative exemplary template, further meta-data parameters regarding coverage area may be used to specify one among a number of alternative coverage areas available from a given orbital slot). Various content-descriptive parameters 1004, 1005, 1006, 1007, 1008, 1009, 1010, 1011, 1012, and/or 1013, are mandated by the system operator in order to guide and coordinate the use of the system and system resources in an efficient fashion. For example knowledge of maximum bit rate and time period of transmission for multiple events enables system capacity to be divided with known limits and protections against overlap or system failure induced by insignificant system capacity occurring when two accepted events conflict with one another. The estimated number of recipients 1014, can be used as previously suggested together with distribution cost models to direct content to the most cost effective network alternative, satellite or Internet or other.

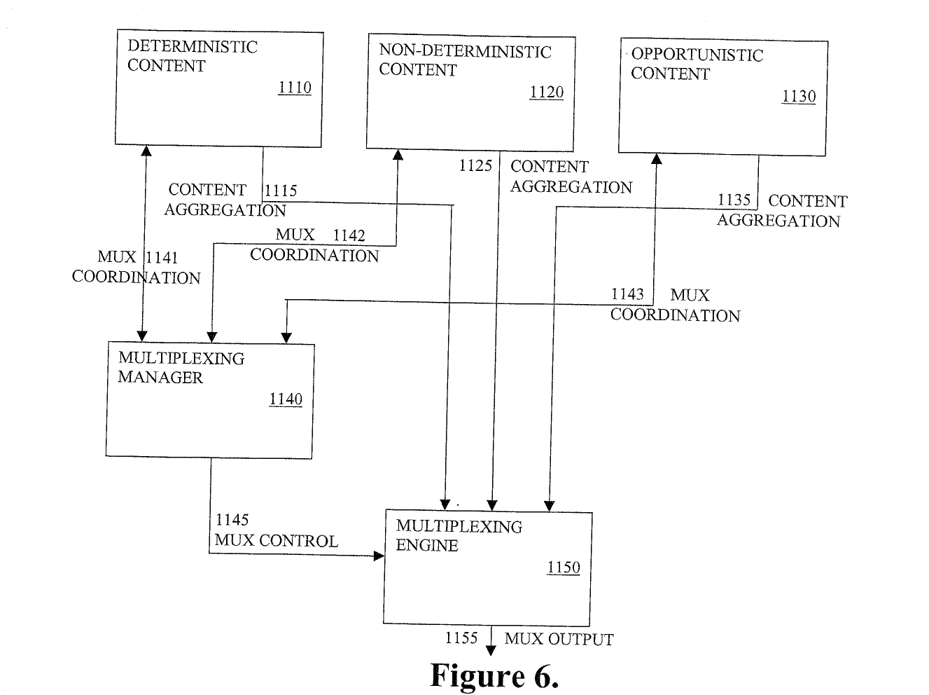

FIG. 6 illustrates a preferred embodiment of a content multiplexer, including staged content of three types: deterministic content 1110 (known bit rate over time), non-deterministic content 1120 (unknown, or insufficiently known bit rate over time—although a maximum bit rate may be required), and opportunistic content 1130 (that is of known volume, but that has less stringent temporal distribution requirements, so that when opportunity to have some of the content sent, it may be sent in interstitial content spaces to effect fuller use of the content transmission channel/mux output 1155). In addition, a multiplexing manager 1140, performs the management function using information 1141, 1142, 1143, from all of the types of staged content 1110, 1120, and 1130, as well as information about the multiplexer engine 1150, capabilities, and the transmission channel, together with algorithms for efficient loading of the transmission channel (taking into account temporal transmission requirements, as well as size and nature of content). According to the multiplexer manager 1140, determinations are made regarding which content should be aggregated at what time for each content type 1110, 1120, and 1130, with coordination signals 1141, 1142, and 1143, effecting timely aggregation of each content type to the multiplexer engine 1150. In a variation of this preferred multiplexing architecture, the LAN cache subsystem or single computer receiver 500, is furnished with a multichannel demodulator, and the multiplexing process is carried out across multiple mux output channels 1155, rather than just a single mux output 1155.

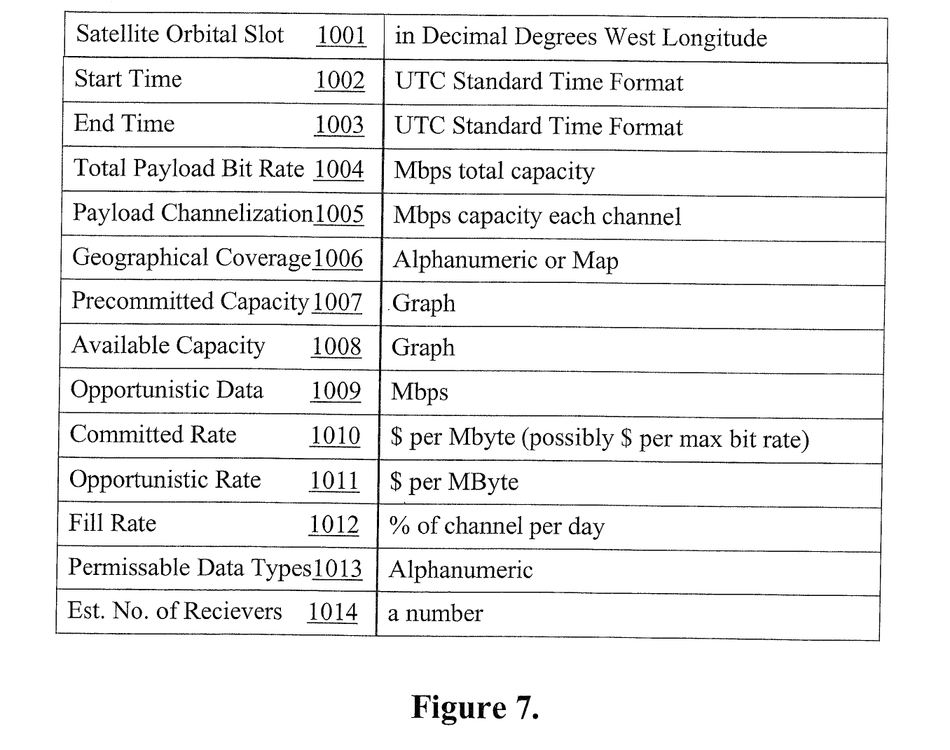

FIG. 7 illustrates an exemplary meta-data template indicating an exemplary set of parameters that may be used to inform prospective content contributors about the nature of the system and currently available system capacity. In this example, the parameters include satellite orbital slot 1001, start time 1002, end time 1003 (start and end times may be specified by prospective content contributor wishing to see system availability), total payload bit rate (sum of maximum bit rates of individual channels) 1004, payload channelization (the maximum bit rate of individual channels, assuming they are identical) 1005, geographical coverage (a diagram of the area covered or a description thereof) 1006, precommitted capacity (what has already been scheduled by other content contributors) 1007, available capacity (the total payload bit rate minus the precommitted capacity) 1008, opportunistic data (data that is less time critical, and may be accommodated according to the opportunity to do so) 1009, committed rate (price per Mbyte for committed capacity) 1010, opportunistic rate (price per Mbyte for opportunistic capacity) 1011, fill rate (a time period average of the % of a channel, or alternatively the % of total system capacity, being committed per day) 1012, permissible data types (description of specific data types or formats, including maximum, or minimums, accepted by the system) 1013, and estimated number of receivers (to promote the value of the scope of the system by its broad reach alternatively additional details can be provided about the content recipients capable of being reached by the system). The use of such system-standard templates detailing system availability enables broad and efficient sharing of system capacity by a wide array of content contributors.

Exemplary Embodiments

In one exemplary embodiment, a satellite neighborhood 100, is established based on the aggregation of businesses reflecting notable vertical-industry communities anticipated to benefit by the present invention—such as services, information technology, finance, insurance, real estate, health care, manufacturing, transportation, public utilities, government, trade, agriculture, mining, construction—and also integrated across vertical industries by the aggregation of cross-industry (e.g. function-specific: legal, sales, business development, management, buying, I.T. staff) content—news, training, etc.

In another exemplary embodiment, access to system content by users on the LAN 600, is by secure authorization in exchange for payment (electronic credit, debit or other such computer- or telephone-based payment method), which may be arranged as a pay-per-view (or pay-per-use) for an individual user from the cache 500, (involving secure storage on the cache 500) or subscription for the entire LAN 600, for some time period (enforced by a similar secure encryption technique) again in exchange for such electronic payment (credit or debit). A further example of such an exemplary embodiment includes the reporting of transactions developed from the use of such a system based on the present invention, thereby permitting collection of a fee (such as a percentage of the transaction amount, or a fixed fee) by the system operator for the functionality provided by the system helping to lead to the transaction. A further example of such an exemplary embodiment includes outsourced installation and maintenance of enterprise system components (LAN-based cache 500, which includes satellite receiving equipment).

Those skilled in the art will recognize that the method and apparatus of the present invention has many applications, and that the present invention is not limited to the representative examples disclosed herein. Moreover, the scope of the present invention covers conventionally known variations and modifications to the system components described herein, as would be known by those skilled in the art.

What is claimed is:

1. A method for managing distribution and storage of content in a distributed system, including a satellite multicast Internet overlay, the Internet, LAN-situated caches, LANs, and/or single computer/device or single cache recipients, in which:
content is distributed to recipients as elected by one or more of the recipient, content originator, or another designated party given such responsibility, using meta-data (descriptive parameters) to index the content and other content-related system parameters for the purposes of notification, selection, distribution, and activity logging (including metered billing),
content destined for a plurality of recipients (for either simultaneous or non-simultaneous access) is multicast via satellite to LAN-situated caches or direct to end user applications,
cache-resident content is further managed for distribution within the enterprise—including on-demand access.

2. The method of claim 1, in which the universe of users is aggregated onto the system advantageously (establishing a valuable neighborhood, or community of users) via a common geo-synchronous orbital location (or set of common orbital locations) from which content is relayed directly to downlink satellite antennas at enterprise or other user locations all pointed to the common satellite orbital location(s).

3. The method of claim 1, in which the meta-data categories conform to one of several standardized templates.

4. The method of claim 1, in which content for distribution is directed over the satellite multicast Internet overlay directly to LAN-situated caches or over the traditional Internet according to automated selection with objectives including delivery cost, quality, reliability, or latency.

5. The method of claim 1, in which the satellite multicast Internet overlay involves standard satellite modulation and channel coding, and multimedia packaging (source coding, data compression, packetization, etc.) such as defined in industry standards such as the set of Digital Video Broadcasting (DVB) standards.

6. The method of claim 1, in which content and/or meta-data is secured by encryption.

7. The method of claim 1, in which prospective content distributors view system schedules and availability as defined by meta-data templates through the system (delivered via the Internet or the satellite-multicast overlay or stored locally on a LAN-situated cache or single-computer hard disk).

8. The method of claim 1, in which content recipients are provided a selective view of content schedules according to a filter corresponding to the recipients identity and the positive association of such identity with any defined group selected by the content originator to have access to the schedule for certain content controlled by content originator.

9. The method of claim 1, in which content access is enabled according to free, pay-per-view, or subscription status, coincident with secure control to preclude unauthorized access to content, and coincident with distributed content management control signals used for conditional access, billing, etc.

10. The method of claim 1, in which content production and preparation tools produce such meta-data for distributed content management and delivery consistent with such meta-data templates or consistent with specific meta-data limits or objectives used to prescribe or control one or more of the parameters of the content being prepared.

11. The method of claim 1, in which certain content to be delivered is backhauled via dedicated or shared data circuits or the Internet to a centralized queue or multiplexer for combination with other content to be sent over the satellite multicast Internet overlay portion of the system.

12. The method of claim 11, in which the backhaul transmissions are included as controlled content management events by the distributed content management system.

13. The method of claim 1, in which content access rules for recipients and other system parameters are passed as supplementary such meta-data.

14. The method of claim 1, in which a software agent program at the recipient location is used to control management of content filtering from the satellite multicast Internet overlay or traditional Internet delivery paths as well as to manage local content access by the recipient (over the LAN or within the subsystems of a single computer system destination).

15. The method of claim 1, in which content guide software located within the enterprise or general user's location enables content schedule viewing, monitoring of local system use and status (including reporting to other elements of the distributed content management system), selection of content for viewing (including decryption), and enabling of other transactions associated with the system.

16. The method of claim 1, in which the multiplexing for satellite multicast Internet overlay delivery is optimized for efficient loading, considering factors such as size and nature of content, and timing requirements for delivery.

17. The method of claim 1, in which multiple modulated carriers sent over the satellite multicast Internet overlay are simultaneously received and processed for access.

18. The method of claim 1, in which meta-data is formatted for delivery in the format of XML or one of its implementations or derivatives.

19. The method of claim 1, in which service charges are collected for one or all of management of the system, access to system content, distribution of content over the system, and transactions (such as purchases of other products or services) relating to the operation of the system or resulting from use of the system.

20. The method of claim 1, in which users of the current satellite multicast to enterprise technology (e.g., and without exclusion, analog or digital business television satellite network users) are aggregated on traditional business terms (i.e., in advance of implementation of the other claims of the present invention) to expand the neighborhood (as in claim 2) enabling upselling the traditional users into the more broadly functional system as it becomes available and accelerating the establishment of a valuable neighborhood by accelerating the number of downlink antennas pointed at the satellite, and thereby accelerating the prospects for early and wide adoption of the shared satellite network portion of a distributed content management system such as described in the present invention.

21. The method of claim 1, in which use of the system is expanded by promoting the system functionality between business partners and the use of the system by businesses or other organizations that are content contributors who desire their business partners to have access to their broadband multimedia content; and who consequently are incentivized to promote the use of the system by their business partners.

22. The method of claim 1, in which the service is marketed by co-branding between the distributed content delivery service brand and one or more or the users' brands of users using the distributed content delivery service, including exploitation of acquired content brands.
